(19) United States
(12) Patent Application Publication
(10) Pub. No.: US 2015/0303770 A1
(43) Pub. Date: Oct. 22, 2015

(54) Modular Power Generation Systems and Methods of Use

(71) Applicants: Brent J. Beissler, Lafayette, IN (US); Robert M. Cain, JR., West Lafayette, IN (US); David Girtz, Monticello, IN (US)

(72) Inventors: Brent J. Beissler, Lafayette, IN (US); Robert M. Cain, JR., West Lafayette, IN (US); David Girtz, Monticello, IN (US)

(21) Appl. No.: 14/255,812

(22) Filed: Apr. 17, 2014

(51) Int. Cl. H02K 7/18; B65D 85/68; B65D 90/00; B65D 88/12; B65D 88/02

(52) U.S. Cl. CPC H02K 7/1815; B65D 88/121; B65D 88/022; B65D 90/0006; B65D 85/68; B65D 2585/6877

(57) ABSTRACT

Disclosed are modular power generation systems and methods of use comprising in various example embodiments a first ISO shipping container housing a power generation unit and a second ISO shipping container housing a fuel system, for instance for alternative fuels, wherein the first and second ISO shipping containers may be removably connected together and shipped, stored, and/or used as an integrated unit while also allowing easy change out of fuel systems and/or power generation units.

### TECHNICAL FIELD

This invention relates generally to power systems, and more particularly to power generation systems with modular features.

### BACKGROUND

In the mobile power generation industry today, typically the only fuel used is diesel fuel. This is due primarily to the wide availability and easy portability of diesel fuel. However, regulatory agencies around the world have recently promulgated regulations strictly limiting the emission levels of internal combustion engines and, in particular, diesel engines that power various equipment such as electrical generators. Additionally, diesel fuel has become relatively expensive for a variety of reasons, and it is forecast that other fuels, such as natural gas, may decrease in price. For these and other reasons there is a need for a mobile power generation system adapted to run on one or more alternative fuels, such as compressed natural gas (CNG) or liquid natural gas (LNG), for instance instead of or in addition to diesel fuel. However, fuel containers and systems for alternative fuels such as CNG or LNG tend to be larger compared to conventional diesel fuel tanks, due to the larger volume of fuel required for the same run time, and to accommodate other fuel-specific considerations, such as high pressure and refrigeration. Accordingly, integrated power generation systems adapted to be readily transported by conventional means have typically not incorporated self-contained fuel systems suitable for alternative fuels. What is needed is a solution that allows a mobile power generation system to run on a variety of alternative fuels for as long as a comparable diesel powered system, while being an integrated unit that is readily transportable by conventional means without requiring over-size permits or other special accommodations.

### SUMMARY

The present invention provides an elegant solution to the needs described above and provides numerous additional benefits and advantages as will be apparent to persons of skill in the art. Provided in various example embodiments is an integrated power generation system adapted to be shipped by conventional means, such as on a single semi-trailer or train car adapted to ship ISO shipping containers, the system including an interchangeable modular fuel system portion adapted to provide a variety of alternative fuels to power the generator, such as CNG or LNG, in sufficient volume to allow a run-time at least as long as a conventional diesel-powered system. For information regarding mobile power generation systems using ISO shipping containers, see U.S. Pat. No. 8,495,869 to Brent J. Beissler et al., published May 3, 2012, which patent is incorporated herein in its entirety by this reference.

By way of example and not limitation, presently provided in one example embodiment is a modular system comprising: a first longitudinally-extending ISO shipping container comprising: a first proximal end comprising two first proximal top attachment fittings and two first proximal bottom attachment fittings; a first distal end comprising two first distal top attachment fittings and two first distal bottom attachment fittings; wherein each of said first proximal top attachment fittings, first proximal bottom attachment fittings, first distal top attachment fittings, and first distal bottom attachment fittings are shaped and positioned in accordance with ISO 1161 to allow the first longitudinally-extending ISO shipping container to be removably mounted on ISO shipping container mounting structures and optionally to be stacked with ISO shipping containers; said first longitudinally-extending ISO shipping container housing a power generation unit comprising a power source that consumes a fuel and exhausts a gas and drives an electrical generator that is capable of generating at least 20 kilowatts of brake power; a second longitudinally-extending ISO shipping container comprising: a second proximal end comprising two second proximal top attachment fittings and two second proximal bottom attachment fittings; a second distal end comprising two second distal top attachment fittings and two second distal bottom attachment fittings; wherein each of said second proximal top attachment fittings, second proximal bottom attachment fittings, second distal top attachment fittings, and second distal bottom attachment fittings are shaped and positioned in accordance with ISO 1161 to allow the second longitudinally-extending ISO shipping container to be removably mounted on ISO shipping container mounting structures and optionally to be stacked with ISO shipping containers; said second longitudinally-extending ISO shipping container housing a fuel storage system comprising one or more fuel containers; and optionally a fuel delivery system adapted to communicate fuel from said one or more fuel containers housed in the second longitudinally-extending ISO shipping container to the power source housed in the first longitudinally-extending shipping container, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending shipping container; wherein the two first proximal top attachment fittings and the two second distal top attachment fittings are adapted to attach with and support an ISO shipping container stacked thereon, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending shipping container.

In various example embodiments the power generation unit may be adapted to run on a plurality of different fuels selected from the group consisting of: diesel fuel, compressed natural gas, liquefied natural gas, and propane. Additionally, in various example embodiments the first longitudinally-extending ISO shipping container may house one or more diesel fuel tanks that provide diesel fuel to the power source. In various example embodiments the one or more fuel containers may comprise one or more cryogenic tanks adapted to store liquefied natural gas, said one or more cryogenic tanks having a total internal volume at least about 1.7 times greater than the total internal volume of the one or more diesel fuel tanks housed in the first ISO shipping container. In various example embodiments the one or more fuel containers may comprise one or more tanks adapted to store compressed natural gas, said one or more tanks having a total internal volume at least about 3.6 times greater than the total internal volume of the one or more diesel fuel tanks housed in the first ISO shipping container. In other embodiments the one or more fuel containers may comprise one or more tanks adapted to store propane, said one or more tanks having a total internal volume at least about 1.4 times greater than the total internal volume of the one or more diesel fuel tanks housed in the first ISO shipping container. In various example embodiments the modular power generation system may be adapted to automatically switch from one fuel to another. For example, in various example embodiments the modular power generation system may be running on relatively unpredictable well head natural gas, sense bad fuel, and automatically switch over to running on propane.

In various example embodiments the longitudinal distance from the first proximal top attachment fittings to the first distal top attachment fittings may be about 20 feet, the longitudinal distance from the second proximal top attachment fittings to the second distal top attachment fittings may be about 20 feet, and the longitudinal distance from the two first proximal top attachment fittings to the two second distal top attachment fittings may be about 40 feet, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending shipping container. In various example embodiments the first longitudinally-extending ISO shipping container and the second longitudinally-extending ISO shipping container may be adapted to be shipped together, positioned end-to-end, on any structure adapted to ship any two longitudinally-adjacent 20-foot ISO shipping containers. The fuel delivery system may connect the fuel storage system with the power source.

In various example embodiments each of said first proximal bottom attachment fittings, first distal bottom attachment fittings, second proximal bottom attachment fittings, and second distal bottom attachment fittings are attached to a semi-trailer, rail car, ship, or any other suitable structure adapted to ship two longitudinally-adjacent 20-foot ISO shipping containers.

Presently provided in another example embodiment is a method of using a modular system, comprising the steps of: positioning a first longitudinally-extending ISO shipping container housing a power generation unit end-to-end with a second longitudinally-extending ISO shipping container housing a fuel storage system, so that a first distal end of the first longitudinally-extending ISO shipping container is proximate a second proximal end of the second longitudinally-extending shipping container; and connecting a fuel delivery system with the modular system so that the fuel delivery system can communicate fuel from the fuel storage system to the power generation unit; wherein the first longitudinally-extending ISO shipping container comprises: a first proximal end comprising two first proximal top attachment fittings and two first proximal bottom attachment fittings; a first distal end comprising two first distal top attachment fittings and two first distal bottom attachment fittings; wherein each of said first proximal top attachment fittings, first proximal bottom attachment fittings, first distal top attachment fittings, and first distal bottom attachment fittings are shaped and positioned in accordance with ISO 1161 to allow the first longitudinally-extending ISO shipping container to be removably mounted on ISO shipping container mounting structures and optionally to be stacked with ISO shipping containers; said first longitudinally-extending ISO shipping container housing a power generation unit comprising a power source that consumes a fuel and exhausts a gas and drives an electrical generator that is capable of generating at least 20 kilowatts of brake power; wherein the second longitudinally-extending ISO shipping container comprises: a second proximal end comprising two second proximal top attachment fittings and two second proximal bottom attachment fittings; a second distal end comprising two second distal top attachment fittings and two second distal bottom attachment fittings; wherein each of said second proximal top attachment fittings, second proximal bottom attachment fittings, second distal top attachment fittings, and second distal bottom attachment fittings are shaped and positioned in accordance with ISO 1161 to allow the second longitudinally-extending ISO shipping container to be removably mounted on ISO shipping container mounting structures and optionally to be stacked with ISO shipping containers; said second longitudinally-extending ISO shipping container housing a fuel storage system comprising one or more fuel containers; wherein the fuel delivery system is adapted to communicate fuel from said one or more fuel containers housed in the second longitudinally-extending ISO shipping container to the power source housed in the first longitudinally-extending shipping container, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending shipping container; and wherein the two first proximal top attachment fittings and the two second distal top attachment fittings are adapted to attach with and support an ISO shipping container stacked thereon, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending shipping container.

In various example embodiments of the method the power generation unit is adapted to run on a plurality of different fuels selected from the group consisting of: diesel fuel, compressed natural gas, liquefied natural gas, and propane. In various example embodiments of the method the first longitudinally-extending ISO shipping container may house one or more diesel fuel tanks that provide diesel fuel to the power source. In various example embodiments of the method the one or more fuel containers may comprise one or more cryogenic tanks adapted to store liquefied natural gas, said one or more cryogenic tanks having a total internal volume at least about 1.7 times greater than the total internal volume of the one or more diesel fuel tanks housed in the first ISO shipping container. In various example embodiments of the method the one or more fuel containers may comprise one or more tanks adapted to store compressed natural gas, said one or more tanks having a total internal volume at least about 3.6 times greater than the total internal volume of the one or more diesel fuel tanks housed in the first ISO shipping container. In other embodiments the one or more fuel containers may comprise one or more tanks adapted to store propane, said one or more tanks having a total internal volume at least about 1.4 times greater than the total internal volume of the one or more diesel fuel tanks housed in the first ISO shipping container.

In various example embodiments of the method the longitudinal distance from the first proximal top attachment fittings to the first distal top attachment fittings may be about 20 feet, the longitudinal distance from the second proximal top attachment fittings to the second distal top attachment fittings may be about 20 feet, and the longitudinal distance from the two first proximal top attachment fittings to the two second distal top attachment fittings may be about 40 feet, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending shipping container. In various example embodiments the method may include the step of shipping the first longitudinally-extending ISO shipping container and the second longitudinally-extending ISO shipping container together, positioned end-to-end, on a structure adapted to ship any two longitudinally-adjacent 20-foot ISO shipping containers. In various example embodiments of the method the may further comprise the step of attaching each of said first proximal bottom attachment fittings, first distal bottom attachment fittings, second proximal bottom attachment fittings, and second distal bottom attachment fittings to a semi-trailer, rail car, ship, or any other suitable structure adapted to ship two longitudinally-adjacent 20-foot ISO shipping containers. Any other suitable lengths or combination of lengths of ISO shipping containers may be used.

The foregoing summary is illustrative only and is not meant to be exhaustive. Other aspects, objects, and advantages of this invention will be apparent to those of skill in the art upon reviewing the drawings, the disclosure, and the appended claims.

### BRIEF DESCRIPTION OF THE DRAWINGS

FIG. 1 is a side elevation view of a variety of example ISO shipping containers stacked together.

FIG. 2 is a chart depicting the relative volumes of different types of fuels required to provide approximately equivalent run-times for a given output of power from a power generation system;

FIG. 3A is a top perspective view of one example embodiment of a modular power generation system power system, shown assembled on a trailer;

FIG. 3B is a top perspective view of another example embodiment of a modular power generation system power system, shown assembled on a trailer;

FIG. 4A is an exploded right side elevation view of the example embodiment of a modular power generation system power system of FIG. 3A;

FIG. 4B is a right side elevation view of the example embodiment of a modular power generation system power system of FIG. 3A;

FIG. 4C is a top plan view of the example embodiment of a modular power generation system power system of FIG. 3A;

FIG. 5A is an exploded right side elevation view of the example embodiment of a modular power generation system power system of FIG. 3B;

FIG. 5B is a right side elevation view of the example embodiment of a modular power generation system power system of FIG. 3B; and

FIG. 5C is a top plan view of the example embodiment of a modular power generation system power system of FIG. 3B.

### DETAILED DESCRIPTION OF EXAMPLE EMBODIMENTS

Reference will now be made in detail to some specific examples of the invention, including any best mode contemplated by the inventor for carrying out the invention. Examples of these specific embodiments are illustrated in the accompanying drawings. While the invention is described in conjunction with these specific embodiments, it will be understood that it is not intended to limit the invention to the described or illustrated embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these features or specific details. In other instances, components and process operations well known to persons of skill in the art have not been described in detail in order not to obscure unnecessarily the present invention.

Various techniques and mechanisms of the present invention will sometimes be described in singular form for clarity. However, it should be noted that some embodiments may include multiple iterations of a technique or multiple components, mechanisms, and the like, unless noted otherwise. Similarly, various steps of the methods shown and described herein are not necessarily performed in the order indicated, or performed at all in certain embodiments. Accordingly, some implementations of the methods discussed herein may include more or fewer steps than those shown or described.

Further, the techniques and mechanisms of the present invention will sometimes describe a connection, relationship or communication between two or more items or entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

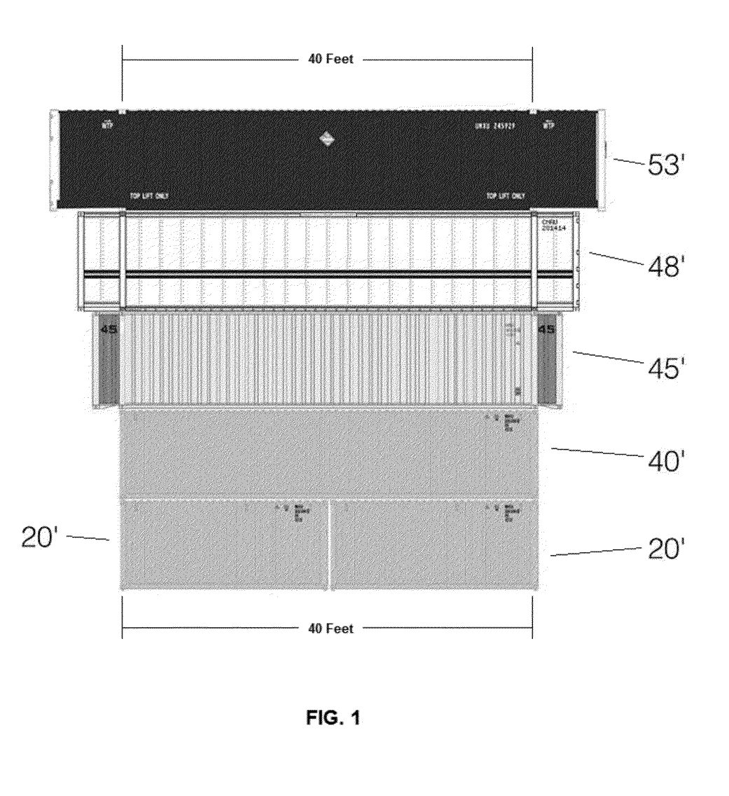

The present disclosure refers to ISO shipping containers, examples of which are depicted stacked together in FIG. 1. For purposes of the present disclosure, the term “ISO shipping container” means a structure formed at least in part from a shipping container manufactured in accordance with ISO 1496 and ISO 1161 or their equivalent, or a structure that shares the outer dimensions of a shipping container manufactured in accordance with ISO 1496 and ISO 1161 or their equivalent sufficiently for the housing to be stacked with shipping containers manufactured in accordance with ISO 1496 and ISO 1161 or their equivalent (regardless whether any or all of said containers are certified or not certified for such stacking). ISO shipping containers may also have external dimensions and other parameters in accordance with ISO 668. The terms ISO 1496, ISO 1161, and ISO 668 refer to any and all versions or editions of those standards as published by the International Organization for Standardization (ISO), which standards are known to persons of skill in the art and are incorporated herein by reference to the extent legally permissible. ISO is a worldwide federation of national standards bodies (ISO member bodies). The work of preparing International Standards is normally carried out through ISO technical committees. Each member body interested in a subject for which a technical committee has been established typically has the right to be represented on that committee. International organizations, governmental and non-governmental, in liaison with ISO, also take part in the work. Draft International Standards adopted by the technical committees are circulated to the member bodies for voting. Publication as an International Standard requires approval by a predetermined percentage of the member bodies casting a vote.

An ISO shipping container (also referred to herein as a container, freight container, intermodal container, shipping container, hi-cube container, box, conex box and sea can) is essentially a standardized reusable steel box or frame used for the safe, efficient and secure storage and movement of materials and products within a global containerized intermodal freight transport system. “Intermodal” indicates that the container can be moved from one mode of transport to another (from ship, to rail, to truck) without unloading and reloading the contents of the container. Lengths of ISO shipping containers typically vary from 8 to 56 feet (2.438 to 17.069 m) and heights from 8 feet (2.438 m) to 9 feet 6 inches (2.896 m). There are reportedly approximately seventeen million intermodal containers in the world of varying types to suit different cargoes. Aggregate container capacity is often expressed in twenty-foot equivalent units (TEU) which is a unit of capacity equal to one standard 20 feet×8 feet (6.10 m×2.44 m) (length×width) ISO shipping container.

ISO standards for containers were first published several decades ago. These standards allow for consistent loading, transporting, and unloading of goods in ports throughout the world, thereby saving time and resources. A typical ISO shipping container has doors fitted at one end, and comprises a perimeter steel frame and corrugated steel panels (which optionally may be partially or entirely removed or omitted). Other doors, vents, and other features may be added as long as the overall outer dimensional envelope meets ISO parameters for shipping and stacking of ISO shipping containers. Containers were originally eight feet (2.44 m) wide (96 inches wide) by eight feet (2.44 m) high, and either a nominal twenty feet (6.1 m) or forty feet (12.19 m) long. They can typically be stacked up to seven units high. At each of eight corners are castings with openings for twistlock fasteners, described below. The standard height is now eight feet six inches. Taller units have been introduced, including “hi-cube” or “high-cube” units at nine feet six inches (2.896 m) and ten feet six inches (3.2 m) high. The United States and Canada often use longer units at forty eight feet (14.63 m) and fifty three feet (16.15 m) long. So-called “domestic” ISO containers are typically fifty-three feet long and 102 inches wide. Forty foot long containers are the standard unit length, and is the standard distance between load-bearing stacking points, as illustrated in FIG. 1. Forty-five, forty-eight, and fifty-three foot long ISO shipping containers all stack at the forty foot coupling distance, as depicted in FIG. 1. Twenty foot long ISO shipping containers can only be stacked with longer containers if there are two in a row (thus providing a forty foot coupling distance), as shown in FIG. 1. Also, twenty foot long ISO shipping containers are typically not stacked on top of forty foot or longer ISO shipping containers, due to the mounting points being forty feet apart, as indicated in FIG. 1.

ISO shipping containers can typically be transported by container ship, semi-trailer truck, sidelifter, freight trains, and the like as part of a single journey without unpacking, and they may be transferred between these shipping modes by container cranes, sidelifters, or similar standardized lifting equipment at container terminals or elsewhere. Units can be readily secured during handling and in transit using “twistlock” points located at each of the eight corners of the container.

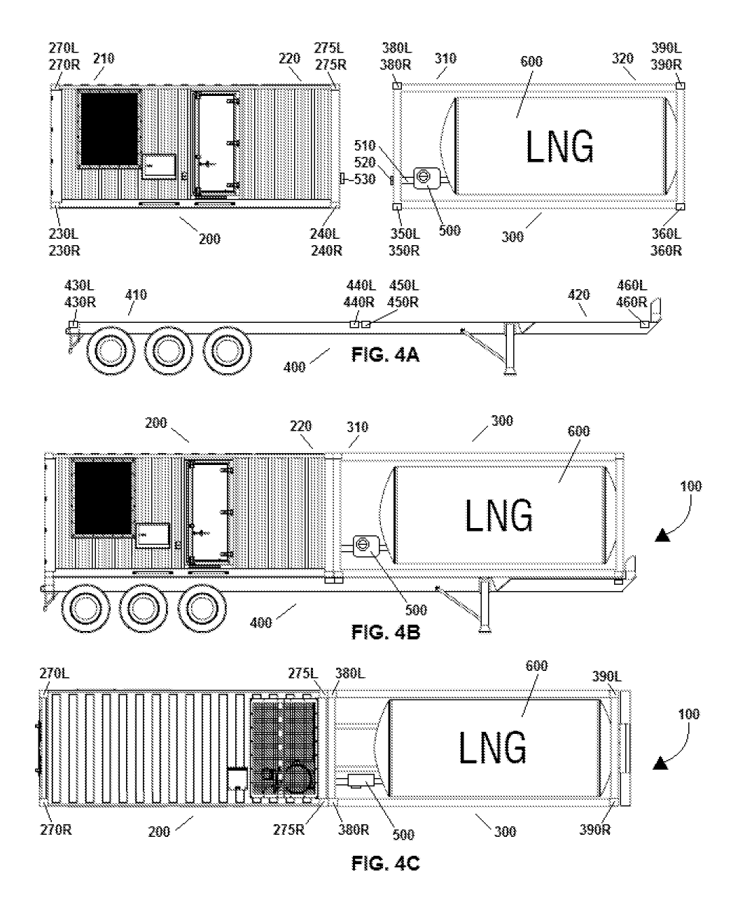

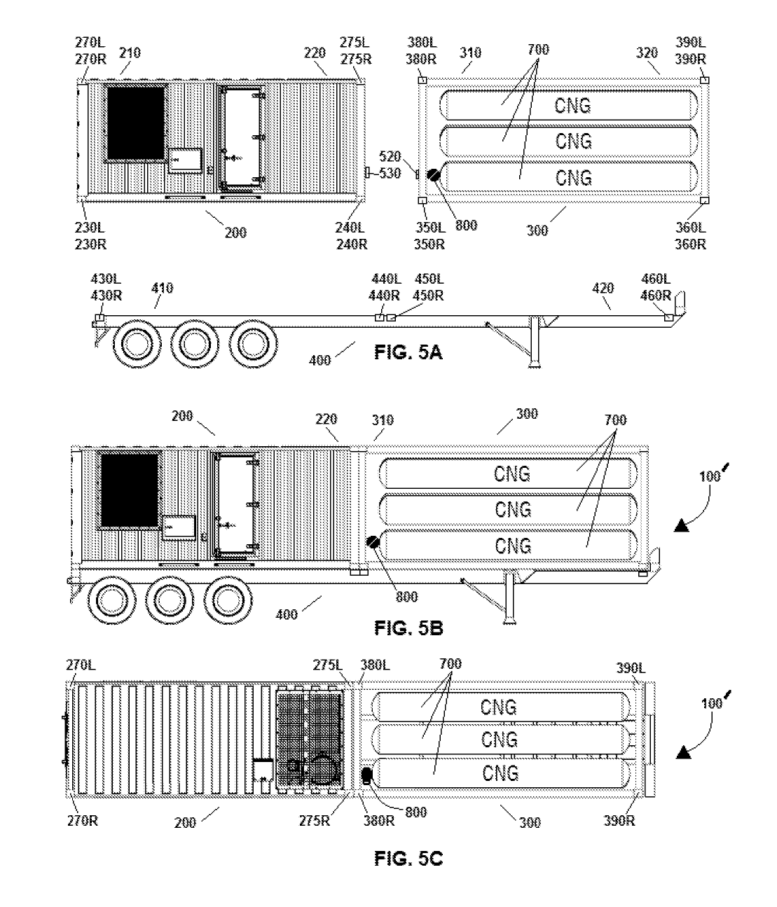

A twistlock (not shown) and corner casting (see FIGS. 4A through 5C at 230L, 230R, 240L, 240R, 270L, 270R, 275L, 275R, and 350L, 350R, 360L, 360R, 380L, 380R, 390L, 390R) together form a standardized rotating connector for securing ISO shipping containers, as is known in the art. An example of this type of mechanism is detailed in U.S. Pat. No. 3,989,294, issued Nov. 2, 1976 to George W. Carr and originally assigned to Pullman Incorporated (the '294 patent), and the '294 patent is incorporated herein by reference in its entirety. The primary uses of these types of structures are for locking an ISO shipping container into place on a container ship, semi-truck trailer or railway train car, and for lifting of the containers, for instance by container cranes and sidelifters. The coupling holes in the corner castings are female and a double-male twist lock may be used to securely mate container stacks together, as is known in the art. The female part of the connector comprises an approximately 7×7×4.5 inches (180×180×110 mm) corner casting fitted to eight corners of the container itself, and it has no moving parts, only an oval hole in the bottom. The hole is an oval 4.9 inches (124.5 mm) on the long axis with two flat sides 2.5 inches (63.5 mm) apart. The male component is the twistlock, which is fitted to cranes and transport bases. The twistlock can be inserted through the hole in the corner casting (the twistlock is roughly 4.1 in or 104.1 mm long and 2.2 in or 55.9 mm wide), and then the top portion of the twistlock (normally pointed to make insertion easier) is rotated approximately 90 degrees so that the twistlock cannot be withdrawn from the corner casting. The mechanism is essentially the same as that of a Kensington lock, but on a much larger scale. The maximum size and position of the holes in the connector is presently defined in international standard ISO 1161:1984, which is known to persons of skill in the art and is incorporated herein by reference to the extent legally permissible. While the standard nomenclature for the female portion is “corner casting,” that portion need not be formed by casting, and may alternatively be formed in whole or in part by machining, forging, or any other suitable manufacturing technique, and may be formed from any suitable material.

A major advantage of this approach to attachment is that containers, which may be stored or transported without being inspected for months at a time, do not require any maintenance in order to function effectively. Even with long-term exposure to weather the containers remain as simple to move as ever. Only when corrosion is very extensive (to the extent of being easily visible by the mover) does the twistlock become dangerous to use to move the container. The male twistlock portions may be placed on vehicles and equipment that are typically inspected regularly, and will effectively work with all containers built to the applicable ISO standards.

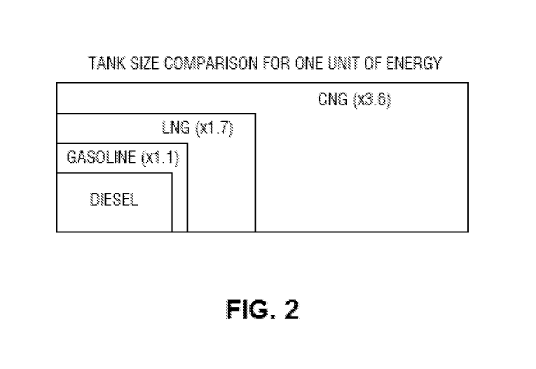

Due to the wide availability and easy transportability of ISO shipping containers, mobile power generation systems have been created that use or fit into ISO shipping containers. For example, see U.S. Pat. No. 8,495,869 to Brent J. Beissler et al., published May 3, 2012, which patent is incorporated herein in its entirety by this reference. However, in the past the only fuel typically used for mobile power generation systems has been diesel fuel. This is due primarily to the wide availability and easy portability of diesel fuel. However, regulatory agencies around the world have recently promulgated regulations strictly limiting the emission levels of internal combustion engines and, in particular, diesel engines that power various equipment such as electrical generators. Thus, there is a need for a mobile power generation system adapted to run on one or more alternative fuels, such as compressed natural gas (CNG) or liquid natural gas (LNG), for instance instead of or in addition to diesel fuel. However, fuel containers and systems for alternative fuels such as CNG or LNG tend to be larger compared to conventional diesel fuel tanks, due to the larger volume of fuel required for the same run time, and to accommodate other fuel-specific considerations, such as high pressure and refrigeration. For example, as shown in FIG. 2, it takes 1.1 times as much volume of gasoline, 1.7 times as much volume of LNG, and 3.6 times as much volume of CNG (all in equivalent water gallons), to provide the same energy output as a given volume of diesel fuel. Accordingly, integrated power generation systems adapted to be readily transported by conventional means have typically not incorporated self-contained fuel systems suitable for alternative fuels, but rather have used the more compact diesel fuel, so that the fuel container(s) can fit inside the housing of the mobile power generation system.

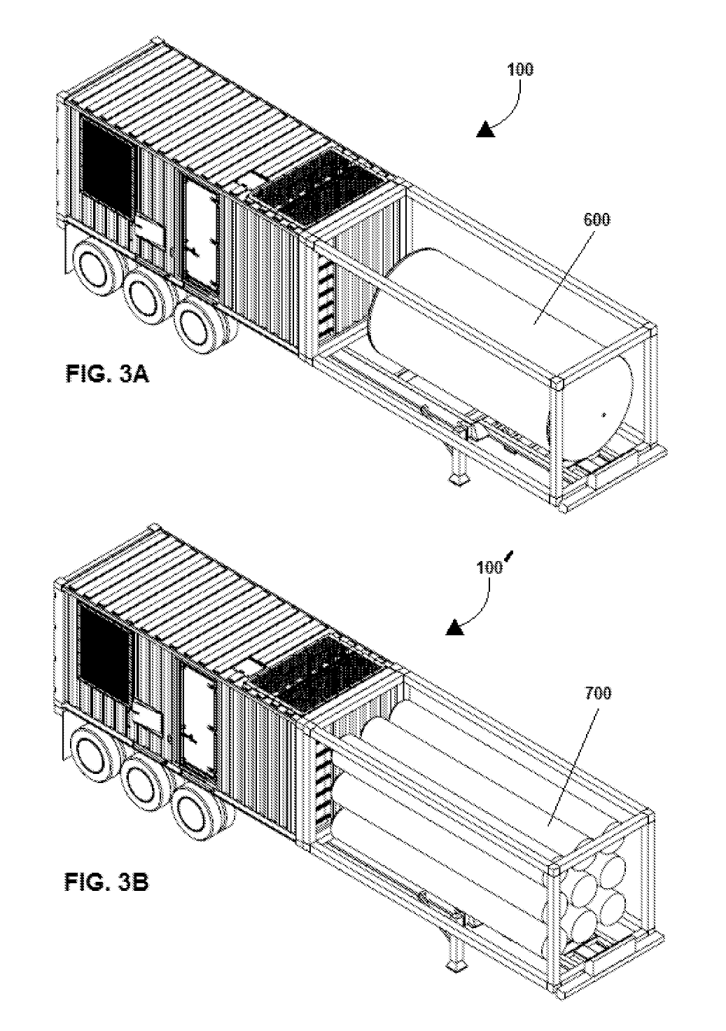

Provided herein is a novel modular solution that allows a mobile power generation system to run on a variety of alternative fuels for at least as long as a comparable diesel powered system, while still being an integrated unit that is readily transportable by conventional means without requiring over-size permits, special trailers or rail cars, special moving equipment, or other special accommodations. By way of example and not limitation, shown in FIGS. 3A and 3B are two example embodiments of integrated power generation systems 100, 100′ adapted to be shipped by conventional means, such as on any conventional single semi-trailer, train car (not shown) or ship (not shown) adapted to ship ISO shipping containers, the system including an interchangeable modular fuel system portion housed in its own ISO shipping container and adapted to provide a large volume of alternative fuels such as CNG or LNG to power a generator system located in an adjacent ISO shipping container, the fuel volume being sufficient to allow a run-time suitable for a mobile generator system housed entirely within an ISO shipping container. In various example embodiments the fuel volume may be sufficient to allow a run-time approximately the same as or at least as long as a conventional diesel-powered mobile generator system housed entirely within an ISO shipping container.

With reference to FIGS. 4A, 4B, 4C, and 5A, 5B, 5C, presently provided in various example embodiments are modular power generation systems 100, 100′ comprising: a first longitudinally-extending ISO shipping container 200 comprising: a first proximal end 210 comprising two first proximal top attachment fittings 270L, 270R and two first proximal bottom attachment fittings 230L, 230R; a first distal end 220 comprising two first distal top attachment fittings 275L, 275R and two first distal bottom attachment fittings 240L, 240R; wherein each of said first proximal top attachment fittings 270L, 270R, first proximal bottom attachment fittings 230L, 230R, first distal top attachment fittings 275L, 275R, and first distal bottom attachment fittings 240L, 240R are shaped and positioned in accordance with ISO 1161 (known in the art and incorporated herein by reference) to allow the first longitudinally-extending ISO shipping container 200 to be removably mounted on ISO shipping container mounting structures (e.g., 430L, 430R, 440L, 440R, 450L, 450R, 460L, 460R) and optionally to be stacked with ISO shipping containers, for instance as shown in FIG. 1; said first longitudinally-extending ISO shipping container 200 housing a power generation unit comprising a power source that consumes a fuel and exhausts a gas and drives an electrical generator that is capable of generating at least 20 kilowatts of brake power (see, e.g., U.S. Pat. No. 8,495,869 to Brent J. Beissler et al., published May 3, 2012 and incorporated herein by reference); a second longitudinally-extending ISO shipping container 300 comprising: a second proximal end 310 comprising two second proximal top attachment fittings 380L, 380R and two second proximal bottom attachment fittings 350L, 350R; a second distal end 320 comprising two second distal top attachment fittings 390L, 390R and two second distal bottom attachment fittings 360L, 360R; wherein each of said second proximal top attachment fittings 380L, 380R, second proximal bottom attachment fittings 350L, 350R; second distal top attachment fittings 390L, 390R, and second distal bottom attachment fittings 360L, 360R are shaped and positioned in accordance with ISO 1161 to allow the second longitudinally-extending ISO shipping container 300 to be removably mounted on ISO shipping container mounting structures (e.g., 430L, 430R, 440L, 440R, 450L, 450R, 460L, 460R) and optionally to be stacked with ISO shipping containers, for instance as shown in FIG. 1; said second longitudinally-extending ISO shipping container 300 housing a fuel storage system comprising one or more fuel containers 600 and/or 700; and optionally a fuel delivery system 500 and/or 800 adapted to communicate fuel from said one or more fuel containers 600 and/or 700 housed in the second longitudinally-extending ISO shipping container 300 to the power source (not shown) housed in the first longitudinally-extending ISO shipping container 200, when the first longitudinally-extending ISO shipping container 200 is positioned end-to-end with the second longitudinally-extending ISO shipping container 300 so that the first distal end 220 of the first longitudinally-extending ISO shipping container 200 is proximate the second proximal end 310 of the second longitudinally-extending ISO shipping container 300 (for instance as shown in FIGS. 3A, 3B, 4B, 4C, 5B, 5C); wherein the two first proximal top attachment fittings 270L, 270R and the two second distal top attachment fittings 390L, 390R are adapted to attach with and support an ISO shipping container stacked thereon (for instance as shown in FIG. 1), when the first longitudinally-extending ISO shipping container 200 is positioned end-to-end with the second longitudinally-extending ISO shipping container 300 so that the first distal end 220 of the first longitudinally-extending ISO shipping container 200 is proximate the second proximal end 310 of the second longitudinally-extending ISO shipping container 300 (for instance as shown in FIGS. 3A, 3B, 4B, 4C, 5B, 5C). In any of the embodiments herein, any or all of the top attachment fittings may optionally be omitted or modified in the event other ISO containers are not going to be stacked thereon.

In various example embodiments the power generation unit (not shown but see, e.g., U.S. Pat. No. 8,495,869 to Brent J. Beissler et al., published May 3, 2012 and incorporated herein by reference) (hereafter “Beissler”) may be adapted to run on one or more of a plurality of different fuels selected among the group consisting of: diesel fuel, compressed natural gas, liquefied natural gas, and propane. Alternatively, any other suitable fuel may be used, such as propane, hydrogen, biodiesel, ethanol, kerosene, jet fuel, bio-fuels, liquefied petroleum gas, compressed air, liquid nitrogen, or any other potential fuel. For example, the power generation unit may be adapted to run exclusively on an alternative fuel other than diesel, or it may be a diesel unit adapted to run bi-fuel or multi-fuel, or it may be a diesel unit adapted to be supplemented simultaneously with an alternative fuel, such as hydrogen, for example. Additionally, in various example embodiments the first longitudinally-extending ISO shipping container 200 may house one or more diesel fuel tanks that provide diesel fuel to the power source (see, e.g., Beissler). In various example embodiments the one or more fuel containers 600 and/or 700 may comprise one or more cryogenic tanks adapted to store liquefied natural gas or other fuel stored cold, said one or more cryogenic tanks 600 and/or 700 having a total internal volume at least about 1.7 times greater than the total internal volume of the one or more diesel fuel tanks, if any, housed in the first ISO shipping container 200. In various example embodiments the one or more fuel containers 600 and/or 700 may comprise one or more tanks adapted to store compressed natural gas, said one or more tanks 600 and/or 700 having a total internal volume at least about 3.6 times greater than the total internal volume of the one or more diesel fuel tanks, if any, housed in the first ISO shipping container 200. In other embodiments the one or more fuel containers 600 and/or 700 may comprise one or more tanks adapted to store propane, said one or more tanks having a total internal volume at least about 1.4 times greater than the total internal volume of the one or more diesel fuel tanks housed in the first ISO shipping container 200.

In one example embodiment utilizing 20 foot long ISO shipping containers for both the first and second ISO shipping containers 200, 300, in a first example configuration adapted to provide LNG (FIGS. 4A, 4B, 4C), the system 100 can be provided with a second ISO shipping container 300 having a collective size of its one or more tanks 600 of 4,500 gallons (water gallons), or about 371,700 standard cubic feet (SCF) of natural gas at 3,600 pounds per square inch (psi), which would have an equivalent energy in gasoline gallons (GGE) of about 2,960 GGE, and an equivalent energy in diesel gallons (DGE) of about 2,615 DGE. In a second example configuration adapted to provide CNG (FIGS. 5A, 5B, 5C), the system 100′ can be provided with a second ISO shipping container 300 having a collective size of its one or more tanks 700 of 3,350 gallons (water gallons), or about 134,000 standard cubic feet (SCF) of natural gas at 3,600 pounds per square inch (psi), which would have an equivalent energy in gasoline gallons (GGE) of about 1,057 GGE, and an equivalent energy in diesel gallons (DGE) of about 931 DGE.

In any or all of the above example embodiments, the power generation unit housed within a 20 foot or larger ISO shipping container 200 may comprise a power source that consumes a fuel and exhausts a gas and drives an electrical generator that is capable of generating at least 20 kilowatts of brake power, or at least 30 kilowatts of brake power, or at least 50 kilowatts of brake power, or at least 75 kilowatts of brake power, or at least 100 kilowatts of brake power, or at least 150 kilowatts of brake power, or at least 200 kilowatts of brake power, or at least 250 kilowatts of brake power, or at least 300 kilowatts of brake power, or at least 350 kilowatts of brake power, or at least 400 kilowatts of brake power, or at least 450 kilowatts of brake power, or at least 500 kilowatts of brake power, or at least 1000 kilowatts of brake power, or at least 1500 kilowatts of brake power, or at least 2000 kilowatts of brake power, or at least 2500 kilowatts of brake power.

By way of example and not limitation, the configurations described above demonstrate the modularity of the present power generation systems in that the first configuration 100 can be switched to the second configuration 100′, and vice-versa, simply by disconnecting the fuel system and removing and replacing one ISO shipping container with another ISO shipping container. Note that while the second ISO shipping container 300 shown in the example embodiments in the Figures is shown without outer panels, any or all sides of the container 300 may alternatively be provided with any suitable panels as will be evident to persons of skill in the art. But even with no outer panels, the structure shown comprising a framework defines an ISO shipping container 300.

In various example embodiments the longitudinal distance from the first proximal top attachment fittings 270L, 270R to the first distal top attachment fittings 275L, 275R may be about 20 feet (or in another embodiment about 40 feet), the longitudinal distance from the second proximal top attachment fittings 380L, 380R to the second distal top attachment fittings 390L, 390R may be about 20 feet (or in another embodiment about 40 feet), and the longitudinal distance from the two first proximal top attachment fittings 270L, 270R to the two second distal top attachment fittings 390L, 390R may be about 40 feet (or in another embodiment about 80 feet), when the first longitudinally-extending ISO shipping container 200 is positioned end-to-end with the second longitudinally-extending ISO shipping container 300 so that the first distal end 220 of the first longitudinally-extending ISO shipping container 200 is proximate the second proximal end 310 of the second longitudinally-extending ISO shipping container 300 (for instance as shown in FIGS. 3A, 3B, 4B, 4C, 5B, 5C). The term “about 40 feet” means nominally approximately 40 feet, plus or minus normal dimensional variations as occur with the manufacturing and positioning of ISO shipping containers pursuant to the applicable ISO standards noted herein. In various example embodiments the first longitudinally-extending ISO shipping container 200 and the second longitudinally-extending ISO shipping container 300 may be adapted to be shipped together, positioned end-to-end, on any structure adapted to ship any two longitudinally-adjacent ISO shipping containers, such as a conventional semi-trailer 400 designed to haul ISO shipping containers.

The fuel delivery system 500 or 800 may be provided on board the second ISO shipping container 300 and may connect the fuel storage system and containers 600 and/or 700 with the power source (not shown) in the first ISO shipping container 200, for instance via appropriate plumbing 510 and removably attachable fittings 520, 530. The fuel delivery system 500 or 800 may comprise fuel pressure and flow regulation components, valves, gauges, gasification components, or any other components necessary to deliver a given type of fuel. Alternatively, any or all of the components of the fuel delivery system 500 or 800 may be provided on board the first ISO shipping container 200.

In various example embodiments each of said first proximal bottom attachment fittings 230L, 230R, first distal bottom attachment fittings 240L, 240R, second proximal bottom attachment fittings 350L, 350R, and second distal bottom attachment fittings 360L, 360R are attached to or attachable to a semi-trailer, rail car, ship, or any other suitable structure adapted to ship two longitudinally-adjacent 20-foot ISO shipping containers. For example, in the case of a semi-trailer 400 extending from a proximate rear end 410 to a distal front end 420 as shown in FIGS. 4A through 5C (front being the normal forward direction of travel of the trailer 400), first proximal bottom attachment fittings 230L, 230R are attached to or attachable to corresponding ISO shipping container attachment fittings or mounting structures 430L, 430R, respectively (L and R designations meaning corresponding left and right sides when facing in the forward direction of travel of the trailer 400), first distal bottom attachment fittings 240L, 240R are attached to or attachable to corresponding ISO shipping container attachment fittings or mounting structures 440L, 440R, respectively, second proximal bottom attachment fittings 350L, 350R are attached to or attachable to corresponding ISO shipping container attachment fittings or mounting structures 450L, 450R, respectively, and second distal bottom attachment fittings 360L, 360R are attached to or attachable to corresponding ISO shipping container attachment fittings or mounting structures 460L, 460R, respectively. The foregoing ISO shipping container attachment fittings or mounting structures (e.g., 430L, 430R, 440L, 440R, 450L, 450R, 460L, 460R) can alternatively be placed on any suitable structure as is known in the art, such as a semi trailer as shown in FIGS. 4A and 5A, a train car, ship, dock, or any other suitable surface or structure, when positioned and located according to applicable ISO standards as noted herein.

Presently provided in another example embodiment is a method of using a modular system 100, 100′, comprising the steps of: positioning a first longitudinally-extending ISO shipping container 200 housing a power generation unit end-to-end with a second longitudinally-extending ISO shipping container 300 housing fuel storage tanks 600 and/or 700, so that a first distal end 220 of the first longitudinally-extending ISO shipping container 200 is proximate a second proximal end 310 of the second longitudinally-extending ISO shipping container 300; and connecting a fuel delivery system 500 and/or 800 with the modular system 100, 100′ so that the fuel delivery system 500 and/or 800 can communicate fuel from the tanks 600 and/or 700 to the power generation unit (not shown, but see, e.g., Beissler); wherein the first longitudinally-extending ISO shipping container 200 comprises: a first proximal end 210 comprising two first proximal top attachment fittings 270L, 270R and two first proximal bottom attachment fittings 230L, 230R; a first distal end 220 comprising two first distal top attachment fittings 275L, 275R and two first distal bottom attachment fittings 240L, 240R; wherein each of said first proximal top attachment fittings 270L, 270R, first proximal bottom attachment fittings 230L, 230R, first distal top attachment fittings 275L, 275R, and first distal bottom attachment fittings 240L, 240R are shaped and positioned in accordance with ISO 1161 (known in the art and incorporated herein by reference) to allow the first longitudinally-extending ISO shipping container 200 to be removably mounted on ISO shipping container mounting structures (e.g., 430L, 430R, 440L, 440R, 450L, 450R, 460L, 460R) and optionally to be stacked with ISO shipping containers, for instance as shown in FIG. 1; said first longitudinally-extending ISO shipping container 200 housing a power generation unit comprising a power source that consumes a fuel and exhausts a gas and drives an electrical generator that is capable of generating at least 20 kilowatts of brake power (see, e.g., Beissler, incorporated herein by reference); a second longitudinally-extending ISO shipping container 300 comprising: a second proximal end 310 comprising two second proximal top attachment fittings 380L, 380R and two second proximal bottom attachment fittings 350L, 350R; a second distal end 320 comprising two second distal top attachment fittings 390L, 390R and two second distal bottom attachment fittings 360L, 360R; wherein each of said second proximal top attachment fittings 380L, 380R, second proximal bottom attachment fittings 350L, 350R; second distal top attachment fittings 390L, 390R, and second distal bottom attachment fittings 360L, 360R are shaped and positioned in accordance with ISO 1161 to allow the second longitudinally-extending ISO shipping container 300 to be removably mounted on ISO shipping container mounting structures (e.g., 430L, 430R, 440L, 440R, 450L, 450R, 460L, 460R) and optionally to be stacked with ISO shipping containers, for instance as shown in FIG. 1; said second longitudinally-extending ISO shipping container 300 housing a fuel storage system comprising one or more fuel containers 600 and/or 700; and optionally a fuel delivery system 500 and/or 800 adapted to communicate fuel from said one or more fuel containers 600 and/or 700 housed in the second longitudinally-extending ISO shipping container 300 to the power source (not shown) housed in the first longitudinally-extending ISO shipping container 200, when the first longitudinally-extending ISO shipping container 200 is positioned end-to-end with the second longitudinally-extending ISO shipping container 300 so that the first distal end 220 of the first longitudinally-extending ISO shipping container 200 is proximate the second proximal end 310 of the second longitudinally-extending ISO shipping container 300 (for instance as shown in FIGS. 3A, 3B, 4B, 4C, 5B, 5C); wherein the two first proximal top attachment fittings 270L, 270R and the two second distal top attachment fittings 390L, 390R are adapted to attach with and support an ISO shipping container stacked thereon (for instance as shown in FIG. 1), when the first longitudinally-extending ISO shipping container 200 is positioned end-to-end with the second longitudinally-extending ISO shipping container 300 so that the first distal end 220 of the first longitudinally-extending ISO shipping container 200 is proximate the second proximal end 310 of the second longitudinally-extending ISO shipping container 300 (for instance as shown in FIGS. 3A, 3B, 4B, 4C, 5B, 5C). In any of the embodiments herein, any or all of the top attachment fittings may optionally be omitted or modified in the event other ISO containers are not going to be stacked thereon.

The above method may further include the steps of removing and replacing either the first and/or the second ISO shipping containers 200, 300, for instance to alternate, refill, or replace the supply of the fuel or its type, or to otherwise mix and match between power generation systems and fuel storage systems. Said removing or replacing can be done easily using known means for transporting, moving, attaching, un-attaching, and re-attaching ISO shipping containers to mating surfaces and/or to each other. The method may further include stacking one or more of the first and/or the second ISO shipping containers 200, 300 with each other and/or with other ISO shipping containers, for instance as shown in FIG. 1.

In various example embodiments the method may further comprise the step of attaching each of said first proximal bottom attachment fittings, first distal bottom attachment fittings, second proximal bottom attachment fittings, and second distal bottom attachment fittings to a semi-trailer, rail car, ship, or any other suitable structure adapted to ship two longitudinally-adjacent ISO shipping containers. Any other suitable lengths or combination of lengths of ISO shipping containers may be used. Additionally, any of the other features or options discussed herein with respect to example systems 100, 100′ may be used in connection with the present method as will be apparent to persons of skill in the art.

Modular power generation systems 100, 100′ featuring ISO shipping container modules 200, 300 that can be removed from and replaced in the systems 100, 100′ as units, and that can together be removably attachable together as a single unit stackable with other ISO shipping containers, provide many benefits over existing power systems that would have to provide separate external means for larger fuel systems in order to run on alternative fuels. Space is conserved, and shipping, set-up and maintenance is easier, quicker, and less expensive. When a presently disclosed modular power generation system 100, 100′ is wholly integrated inside adjacent ISO shipping containers 200, 300 that are either connected together and/or to a common structure such as a trailer 400, the systems 100, 100′ may easily be transported around the world via standard shipping methods. The time and expense of obtaining special permits to transport multiple or non-conforming containers s avoided. Also, generator sets and fuel systems can easily be changed out or interchanged by swapping in different ISO shipping containers 200, 300.

The above description of the disclosed embodiments is provided to enable persons skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein. Other aspects, objects, and advantages of this invention can be obtained from a study of the drawings, the disclosure, and the appended claims.

What is claimed is:

1. A modular system comprising:
a first longitudinally-extending ISO shipping container comprising:
a first proximal end comprising two first proximal bottom attachment fittings;
a first distal end comprising two first distal bottom attachment fittings;
wherein each of said first proximal bottom attachment fittings and first distal bottom attachment fittings are shaped and positioned to allow the first longitudinally-extending ISO shipping container to be removably mounted on ISO shipping container mounting structures;
said first longitudinally-extending ISO shipping container housing a power generation unit comprising a power source that consumes a fuel and exhausts a gas and drives an electrical generator that is capable of generating at least 20 kilowatts of brake power;
a second longitudinally-extending ISO shipping container comprising:
a second proximal end comprising two second proximal bottom attachment fittings;
a second distal end comprising two second distal bottom attachment fittings;
wherein each of said second proximal bottom attachment fittings and second distal bottom attachment fittings are shaped and positioned to allow the second longitudinally-extending ISO shipping container to be removably mounted on ISO shipping container mounting structures;
said second longitudinally-extending ISO shipping container housing a fuel storage system comprising one or more fuel containers; and
a fuel delivery system adapted to communicate fuel from said one or more fuel containers housed in the second longitudinally-extending ISO shipping container to the power source housed in the first longitudinally-extending ISO shipping container, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending ISO shipping container;
wherein the first proximal bottom attachment fittings, the first distal bottom attachment fittings, the second proximal bottom attachment fittings, and the second distal bottom attachment fittings are adapted to removably attach with ISO shipping container mounting structures, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending ISO shipping container.

2. The modular system of claim 1, wherein the power generation unit is adapted to run on a plurality of different fuels selected from the group consisting of: diesel fuel, compressed natural gas, liquefied natural gas, and propane.

3. The modular system of claim 1, further comprising the first longitudinally-extending ISO shipping container housing one or more diesel fuel tanks that provide diesel fuel to the power source.

4. The modular system of claim 3, wherein the one or more fuel containers comprise one or more cryogenic tanks adapted to store liquefied natural gas, said one or more cryogenic tanks having a total internal volume at least about 1.7 times greater than the total internal volume of the one or more diesel fuel tanks housed in the first ISO shipping container.

5. The modular system of claim 3, wherein the one or more fuel containers comprise one or more tanks adapted to store compressed natural gas, said one or more tanks having a total internal volume at least about 3.6 times greater than the total internal volume of the one or more diesel fuel tanks housed in the first ISO shipping container.

6. The modular system of claim 1, wherein the longitudinal distance from the first proximal bottom attachment fittings to the first distal bottom attachment fittings is about 20 feet, the longitudinal distance from the second proximal bottom attachment fittings to the second distal bottom attachment fittings is about 20 feet, and the longitudinal distance from the two first proximal bottom attachment fittings to the two second distal bottom attachment fittings is about 40 feet, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending ISO shipping container.

7. The modular system of claim 6, wherein the first longitudinally-extending ISO shipping container and the second longitudinally-extending ISO shipping container are adapted to be shipped together, positioned end-to-end, on any structure adapted to ship any two longitudinally-adjacent 20-foot ISO shipping containers.

8. The modular system of claim 6, further comprising:
the first longitudinally-extending ISO shipping container positioned end-to-end with the second longitudinally-extending ISO shipping container so that the first distal end of the first longitudinally-extending ISO shipping container is proximate the second proximal end of the second longitudinally-extending ISO shipping container; and
the fuel delivery system connecting the fuel storage system with the power source.

9. The modular system of claim 8, wherein each of said first proximal bottom attachment fittings, first distal bottom attachment fittings, second proximal bottom attachment fittings, and second distal bottom attachment fittings are attached to a semi-trailer adapted to ship two longitudinally-adjacent 20-foot ISO shipping containers.

10. The modular system of claim 8, wherein each of said first proximal bottom attachment fittings, first distal bottom attachment fittings, second proximal bottom attachment fittings, and second distal bottom attachment fittings are attached to a rail car adapted to ship two longitudinally-adjacent 20-foot ISO shipping containers.

11. The modular system of claim 8, wherein each of said first proximal bottom attachment fittings, first distal bottom attachment fittings, second proximal bottom attachment fittings, and second distal bottom attachment fittings are attached to a ship adapted to ship at least two longitudinally-adjacent 20-foot ISO shipping containers.

12. A method of using a modular system, comprising the steps of:
positioning a first longitudinally-extending ISO shipping container housing a power generation unit end-to-end with a second longitudinally-extending ISO shipping container housing a fuel storage system, so that a first distal end of the first longitudinally-extending ISO shipping container is proximate a second proximal end of the second longitudinally-extending ISO shipping container; and
connecting a fuel delivery system with the modular system so that the fuel delivery system can communicate fuel from the fuel storage system to the power generation unit;
wherein the first longitudinally-extending ISO shipping container comprises:
a first proximal end comprising two first proximal bottom attachment fittings;
a first distal end comprising two first distal bottom attachment fittings;
wherein each of said first proximal bottom attachment fittings and first distal bottom attachment fittings are shaped and positioned to allow the first longitudinally-extending ISO shipping container to be removably mounted on ISO shipping container mounting structures;
said first longitudinally-extending ISO shipping container housing a power generation unit comprising a power source that consumes a fuel and exhausts a gas and drives an electrical generator that is capable of generating at least 20 kilowatts of brake power;
wherein the second longitudinally-extending ISO shipping container comprises:
a second proximal end comprising two second proximal bottom attachment fittings;
a second distal end comprising two second distal bottom attachment fittings;
wherein each of said second proximal bottom attachment fittings and second distal bottom attachment fittings are shaped and positioned to allow the second longitudinally-extending ISO shipping container to be removably mounted on ISO shipping container mounting structures;
said second longitudinally-extending ISO shipping container housing a fuel storage system comprising one or more fuel containers;
wherein the fuel delivery system is adapted to communicate fuel from said one or more fuel containers housed in the second longitudinally-extending ISO shipping container to the power source housed in the first longitudinally-extending ISO shipping container, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending ISO shipping container; and
wherein the first proximal bottom attachment fittings, the first distal bottom attachment fittings, the second proximal bottom attachment fittings, and the second distal bottom attachment fittings are adapted to removably attach with ISO shipping container mounting structures, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending ISO shipping container.

13. The method of using a modular system of claim 12, wherein the power generation unit is adapted to run on a plurality of different fuels selected from the group consisting of: diesel fuel, compressed natural gas, liquefied natural gas, and propane.

14. The method of using a modular system of claim 12, wherein the first longitudinally-extending ISO shipping container houses one or more diesel fuel tanks that provide diesel fuel to the power source.

15. The method of using a modular system of claim 14, wherein the one or more fuel containers comprise one or more cryogenic tanks adapted to store liquefied natural gas, said one or more cryogenic tanks having a total internal volume at least about 1.7 times greater than the total internal volume of the one or more diesel fuel tanks housed in the first ISO shipping container.

16. The method of using a modular system of claim 14, wherein the one or more fuel containers comprise one or more tanks adapted to store compressed natural gas, said one or more tanks having a total internal volume at least about 3.6 times greater than the total internal volume of the one or more diesel fuel tanks housed in the first ISO shipping container.

17. The method of using a modular system of claim 14, wherein the one or more fuel containers comprise one or more tanks adapted to store propane, said one or more tanks having a total internal volume at least about 1.4 times greater than the total internal volume of the one or more diesel fuel tanks housed in the first ISO shipping container.

18. The method of using a modular system of claim 12, wherein the longitudinal distance from the first proximal bottom attachment fittings to the first distal bottom attachment fittings is about 20 feet, the longitudinal distance from the second proximal bottom attachment fittings to the second distal bottom attachment fittings is about 20 feet, and the longitudinal distance from the two first proximal bottom attachment fittings to the two second distal bottom attachment fittings is about 40 feet, when the first longitudinally-extending ISO shipping container is positioned end-to-end with the second longitudinally-extending ISO shipping container so that the first distal end of the first longitudinally-extending ISO shipping container is proximate the second proximal end of the second longitudinally-extending ISO shipping container.

19. The method of using a modular system of claim 18, further comprising the step of shipping the first longitudinally-extending ISO shipping container and the second longitudinally-extending ISO shipping container together, positioned end-to-end, on a structure adapted to ship any two longitudinally-adjacent 20-foot ISO shipping containers.

20. The method of using a modular system of claim 19, further comprising the step of attaching each of said first proximal bottom attachment fittings, first distal bottom attachment fittings, second proximal bottom attachment fittings, and second distal bottom attachment fittings to a semi-trailer adapted to ship two longitudinally-adjacent 20-foot ISO shipping containers.
